(19) United States
(12) Patent Application Publication
(10) Pub. No.: US 2022/0230424 A1
(43) Pub. Date: Jul. 21, 2022

(54) Q-VALUE APPROXIMATION FOR DESIRED DECISION STATES

(71) Applicant: SESH Corp., Topanga, CA (US)

(72) Inventors: Kevin Craig Woolery, West Linn, OR (US); Cauri Jaye, Los Angeles, CA (US); David Dorfman, Santa Monica, CA (US)

(21) Appl. No.: 17/575,310

(22) Filed: Jan. 13, 2022

Related U.S. Application Data
(60) Provisional application No. 63/138,148, filed on Jan. 15, 2021.

(51) Int. Cl. G06V 10/778; G06V 10/82; G06V 10/774

(52) U.S. Cl. CPC G06V 10/7796; G06V 10/774; G06V 10/82

(57) ABSTRACT

An online system receives contextual information for a goal-oriented environment at a current time and generates Q-value predictions that indicate likelihoods that one or more participants will reach the desired goal. The Q-value for a current time may also be interpreted as the value of the actions taken at the current time with respect to the desired goal. The online system generates Q-value predictions for a current time by applying an approximator network to the contextual information for the current time. In one instance, the approximator network is a machine learning model neural network model trained by a reinforcement learning process. The reinforcement process allows the approximator network to incrementally update the Q-value predictions given new information throughout time, and results in a more computationally efficient training process compared to other types of supervised or unsupervised machine learning model processes.

### CROSS REFERENCE TO RELATED APPLICATIONS

This application claims the benefit of U.S. Provisional Application No. 63/138,148, filed Jan. 15, 2021, which is incorporated by reference in its entirety.

### BACKGROUND

This disclosure generally relates to prediction of Q-values using decision states, and more specifically to prediction of Q-values using machine learning models for a goal-oriented environment.

Goal-oriented environments occur in various forms and settings, and typically include one or more coordinators and participants with a particular goal. For example, a goal-oriented environment may be a learning environment including a learning coordinator, such as an instructor, and one or more students that wish to learn the subject matter of interest. A goal of the learning environment may be for the students of the learning environment understand or comprehend the subject matter of interest. As another example, a goal-oriented environment may be a sales environment including a salesperson and a potential client for the sale. A goal of the sales environment may be to communicate a successful sales pitch such that the potential client agrees to purchase a product of interest.

Typically, the coordinator or another entity managing the goal-oriented environment takes a sequence of actions directed to achieving the goal. For example, an instructor for a learning environment may intermittently ask questions throughout a lecture to gauge the understanding of the students. As another example, a salesperson for a sales environment may present different types of research analyses showing the effectiveness of the product of interest to persuade the potential buyer. These actions and other contexts surrounding the goal-oriented environment may influence the decision states of the participants over time and thus, may determine whether the participants of the goal-oriented environment are progressing toward the desired goal.

### SUMMARY

An online system receives contextual information for a goal-oriented environment at a current time and generates Q-value predictions that indicate likelihoods that one or more participants will reach the desired goal. The Q-value for a current time may also be interpreted as the value of the actions taken at the current time with respect to the desired goal. The online system generates Q-value predictions for a current time by applying an approximator network to the contextual information for the current time. In one instance, the approximator network is a machine learning model neural network model trained by a reinforcement learning process. The reinforcement process allows the approximator network to incrementally update the Q-value predictions given new information throughout time, and results in a more computationally efficient training process compared to other types of supervised or unsupervised machine learning model processes.

In one embodiment, the online system displays the Q-value predictions as they are generated throughout time, such that the coordinator or another entity managing the environment can monitor whether the participants of the goal-oriented environment are progressing toward the desired goal. For example, if the Q-value predictions are increasing over time, this allows the coordinator to verify that the actions being taken are useful for reaching the desired goal. On the other hand, if the predictions are decreasing over time, this may indicate that the actions being taken are not useful for reaching the desired goal, and the coordinator can modify future action plans to more beneficial ones.

In one embodiment, the contextual information for the goal-oriented environment is encoded as a state, and can include information related to the temporal context, cultural context, personal context, or the like of the goal-oriented environment. In one instance, the current state of the goal-oriented environment includes decision state predictions for one or more participants of the environment over a window of time for temporal context. The decision state predictions may include predictions on whether the participants have achieved a state of understanding or comprehension. In another instance, the current state of the goal-oriented environment includes pixel data for one or more participants obtained from the video stream of the environment over a window of time for temporal context.

The online system trains the approximator network by using a temporal difference (“TD”) learning approach. The TD learning approach trains the set of parameters of the approximator network to generate a Q-value prediction for a current time based on a Q-value prediction for the next time. Specifically, the online system obtains a training dataset that includes a replay buffer of multiple instances of transitional scenes. A transitional scene in the replay buffer includes a video image of an environment at a first time and a video image of the environment at a second time that occurred responsive to an action taken in the environment at the first time. For a transitional scene, the training dataset also includes a reward for the transition that indicates whether the action taken is useful for reaching the desired goal. The reward may be a positive value if the action was useful, a negative value if the action was harmful, or a zero value if the action was neither useful or harmful.

For a transitional scene in the training dataset, the online system generates a first estimated Q-value by applying the approximator network with an estimated set of parameters to the contextual information extracted from the video image for the first time. The online system also generates a target that is a combination of the reward assigned to the transitional scene and a second estimated Q-value generated by applying the approximator network with the estimated set of parameters to the contextual information extracted from the video image for the second time. The online system determines a loss for the transitional scene as a difference between the first estimated Q-value and the target, and a loss function as a combination of losses for a subset of transitional scenes in the training dataset.

The online system updates the set of parameters for the approximator network to reduce the loss function. This process is repeated with different subsets of transitional scenes in the training dataset until a convergence criteria for the set of parameters is reached and the training process is completed. By training the approximator network in this manner, the set of parameters of the approximator network are trained to generate a Q-value prediction for a current time that represents the value of rewards expected over the future.

### BRIEF DESCRIPTION OF THE DRAWINGS

FIG. 1 is a block diagram of a system environment including an online system, in accordance with an embodiment.

FIG. 2 illustrates a general process for using an approximator network to generate Q-value predictions infer learning states of participants in a learning environment, in accordance with an embodiment.

FIG. 3 illustrates a block diagram of the architecture of an online system, in accordance with an embodiment.

FIG. 4 illustrates a training process of an approximator network with a recurrent neural network (RNN) architecture, in accordance with an embodiment.

FIG. 5 illustrates a training process of an approximator network in conjunction with a prediction model with an RNN architecture, in accordance with an embodiment.

FIG. 6 is a flowchart illustrating a training process of an approximator network, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

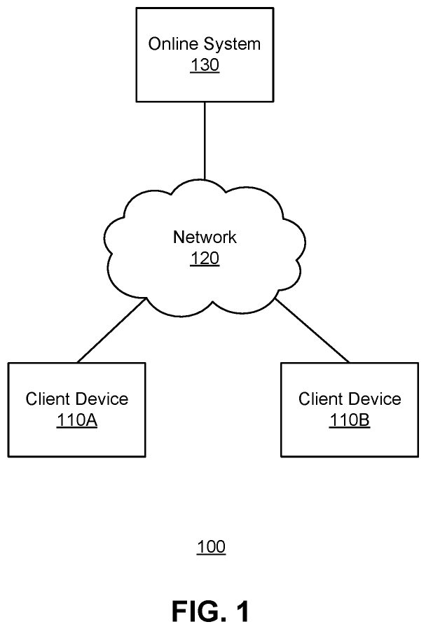

FIG. 1 is a block diagram of a system environment including an online system 130, in accordance with an embodiment. The system environment 100 shown in FIG. 1 comprises an online system 130, client devices 110A, 110B, and a network 120. In alternative configurations, different and/or additional components may be included in the system environment 100.

The online system 130 receives a video stream of an environment and generates Q-value predictions that indicate likelihoods that one or more participants of the environment will reach a desired goal using a reinforcement machine learning model method. Specifically, the video stream may be of a goal-oriented environment that typically includes one or more coordinators and participants with a particular goal. For example, a goal-oriented environment may be a learning environment including a learning coordinator, such as an instructor, and one or more students that wish to learn the subject matter of interest. A goal of the learning environment may be for the students of the learning environment understand or comprehend the subject matter of interest. As another example, a goal-oriented environment may be a sales environment including a salesperson and a potential client for the sale. A goal of the sales environment may be to communicate a successful sales pitch such that the potential client agrees to purchase a product of interest.

The goal-oriented environment captured by the online stream 130 may occur in various forms and settings. For example, a goal-oriented environment may occur in-person at a classroom at an education institution such as a school or university, where an instructor teaches a course to one or more students. In such an instance, the video stream may be taken from an external camera placed within the goal-oriented environment. As another example, a goal-oriented environment may occur virtually on an online platform, where individuals access the platform to participate in an online learning session. The online platform may be an online education system such as a massive open online course (MOOC) system that provides online courses and curriculums to users. In such an instance, the video stream may be obtained from individual camera streams from different participants that capture the participant during a learning session.

Typically, the coordinator or another entity managing the goal-oriented environment takes a sequence of actions directed to achieving the goal. For example, an instructor for a learning environment may intermittently ask questions throughout a lecture to gauge the understanding of the students. As another example, a salesperson for a sales environment may present different types of research analyses showing the effectiveness of the product of interest to persuade the potential buyer. These actions and other contexts surrounding the goal-oriented environment may influence the decision states of the participants over time and thus, may determine whether the participants of the goal-oriented environment are progressing toward the desired goal.

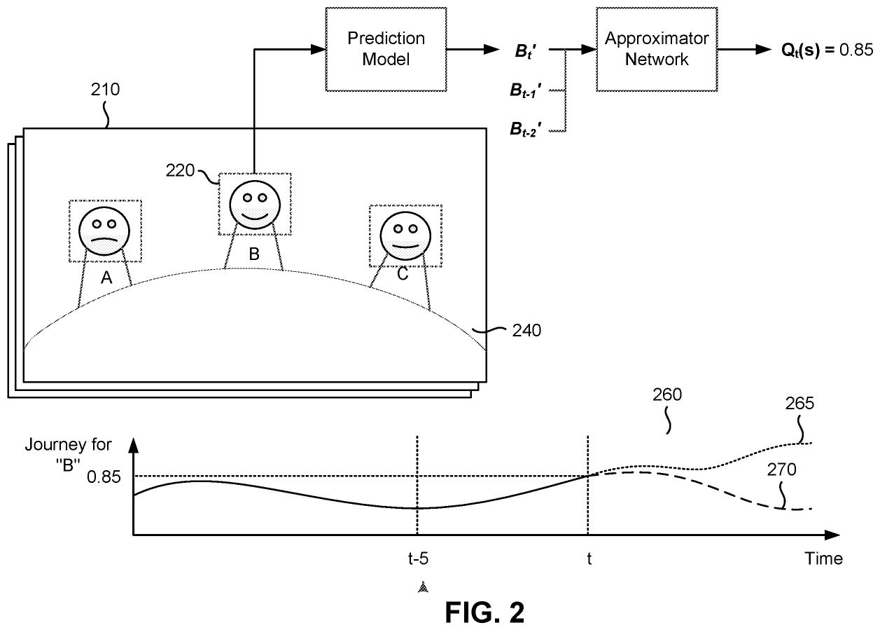

FIG. 2 illustrates a general process for using an approximator network to generate Q-value predictions infer learning states of participants in a learning environment, in accordance with an embodiment. Specifically, FIG. 2 illustrates a goal-oriented environment that is an in-person learning environment that includes image 210 at a current time among other images. The image 210 includes three participants, labeled “A,” “B,” and “C” in the learning environment. In particular, image 210 at the current time may capture a moment when the instructor (not shown) is taking an action of asking a question to participant B in the learning environment about the subject matter of interest.

For one or more images of the video stream, the online system 130 obtains one or more annotations for the image. An annotation indicates a region in the image that includes a face of a corresponding participant. In one embodiment referred throughout the specification, the annotation is a bounding box in the form of a rectangular region that encloses the face of the individual, preferably within the smallest area possible. In another embodiment, the annotation is in the form of labels that assign pixels or groups of pixels in the image that belong to the face of the individual. In one embodiment, the online system 130 obtains the annotation by applying a face detection model to the image. The face detection model is configured to receive pixel data of the image and output a set of annotations for the image that each include a face of an individual in the image. In the example shown in FIG. 2, the online system 130 obtains an annotation in the form of a bounding box 220 for participant “B” that encloses the face of the participant. The online system 130 may obtain similar annotations for participants A and C.

The online system 130 receives contextual information for a goal-oriented environment at a current time and generates Q-value predictions that indicate likelihoods that one or more participants will reach the desired goal. The Q-value for a current time may also be interpreted as the value of the actions taken at the current time with respect to the desired goal. The contextual information may include, for example, information on the temporal context, cultural context, or personal context of the goal-oriented environment. The online system 130 may generate Q-value predictions for a particular participant using contextual information that pertains to the individual participant or may generate Q-value predictions for the environment as a whole by, for example, combining Q-value predictions for each participant in the scene.

In one embodiment, the online system 130 generates Q-value predictions for a current time by applying an approximator network to the contextual information obtained from the video frame for the current time. In one instance, the approximator network is a machine learning model neural network model trained by a reinforcement learning process. Specifically, the reinforcement process allows the approximator network to incrementally update the Q-value predictions given new information throughout time, and results in a more computationally efficient training process compared to other types of machine learning model (e.g., supervised or unsupervised) processes. In one instance, the approximator network is configured as a recurrent neural network (RNN) architecture.

The contextual information for the goal-oriented environment may be encoded as a state, and can include information related to the temporal context, cultural context, personal context, or the like of the goal-oriented environment. In one instance, the current state of the goal-oriented environment includes decision state and sentiment predictions for one or more participants of the environment over a window of time for temporal context. As defined herein, a decision state can be distinguished from a sentiment in that sentiments are temporary, but a decision state can be more lasting and pervasive. Thus, a decision state may differ from a sentiment with respect to the timeframe it lasts in an individual. While sentiments such as anger or happiness may be temporary and momentary emotions, decision states, including learning states such as comprehension and understanding, are more lasting or permanent mental constructs in that the individual will retain the knowledge of a certain topic once the individual has achieved comprehension or understanding of the topic.

As shown in FIG. 2, the online system 130 generates decision state and sentiment predictions Bₜ′ for participant B in the image 210 that may indicate confidence levels on whether the participant B has achieved one or more desired decision states of comprehension and understanding of the subject matter of interest for a current time “t.” The online system 130 generates a current state s for the image 210 by concatenating the decision state and sentiment predictions Bₜ₋₁′, Bₜ₋₂′ for participant B from previous times “t−1” and “t−2” to the decision state predictions Bₜ′ for the current time to provide temporal context. The online system 130 generates a Q-value prediction Qₜ(s,a) for the current state that indicates the value of the action a taken at the current time with respect to the desired goal. The online system 130 may repeat this process to generate Q-value predictions for subsequent times by obtaining the next state from the next video frame and applying the approximator network to the next state information. The online system 130 may also repeat this process to generate Q-value predictions over time for participants A and C.

In one embodiment, the online system 130 generates display information including the Q-value predictions as they are generated throughout time, such that the coordinator or another entity managing the environment can monitor whether the participants of the goal-oriented environment are on a path that is progressing toward the desired goal. For example, the online system 130 may generate display information in the form of a plot that includes a horizontal axis representing time (e.g., time of the video frame) and a vertical axis representing Q-value predictions, and display Q-value predictions as they become available over time. For example, if the Q-value predictions are increasing over time, this allows the coordinator to verify that the actions being taken are useful for reaching the desired goal. On the other hand, if the predictions are decreasing over time, this may indicate that the actions being taken are not useful for reaching the desired goal, and the coordinator can modify future action plans to more beneficial ones.

In the example shown in FIG. 2, the online system 130 displays a plot 260 that includes a horizontal axis representing time of the video frame and a vertical axis representing the Q-value predictions of the participant B. The Q-value predictions for the participant indicate a likelihood that participant B will understand and comprehend the subject being taught by the instructor. As shown in FIG. 2, the Q-value prediction for the current time “t” is 0.85 from a range of [0, 1] indicating a significantly high likelihood that participant B will achieve the desired goal of understanding and comprehension responsive to the action taken by the instructor at or right before that time. Moreover, since the Q-value predictions have generally increased since the previous time “t−5,” this may indicate that participant B is on a path toward reaching the desired goal.

The subsequent plot 265 indicates a future scenario in which the learning coordinator has taken a sequence of actions from the current time “t” that results in participant B reaching the desired goal of understanding and comprehension of the subject matter. Alternatively, the subsequent plot 270 indicates a future scenario where the learning coordinator has taken a sequence of actions from the current time “t” that results in participant B failing to reach the desired goal of understanding and comprehension of the subject matter.

The online system 130 trains the approximator network by using a temporal difference (“TD”) learning approach. The TD learning approach trains the set of parameters of the approximator network to generate a Q-value prediction for a current time based on a Q-value prediction for the next time. Specifically, the online system 130 obtains a training dataset that includes a replay buffer of multiple instances of transitional scenes. One instance of the replay buffer may include multiple transitional scenes in a sequence from a corresponding video stream, where a transitional scene includes a video image of an environment at a first time and a video image of the environment at a second time that occurred responsive to an action taken in the environment at the first time. For a transitional scene, the training dataset also includes a reward for the transition that indicates whether the action taken is useful for reaching the desired goal. The reward may be a positive value if the action was useful, a negative value if the action was harmful, or a zero value if the action was neither useful nor harmful.

For an instance in the training dataset, the online system 130 generates a first estimated Q-value by applying the approximator network with an estimated set of parameters to the contextual information extracted from the video image for the first time. The online system 130 also generates a target that is a combination of the reward assigned to the transitional scene and a second estimated Q-value generated by applying the approximator network with the estimated set of parameters to the contextual information extracted from the video image for the second time. The online system 130 determines a loss for the transitional scene as a difference between the first estimated Q-value and the target, and a loss function as a combination of losses for a subset of transitional scenes in the training dataset.

The online system 130 updates the set of parameters for the approximator network to reduce the loss function. This process is repeated with different subsets of transitional scenes in the training dataset until a convergence criteria for the set of parameters is reached and the training process is completed. By training the approximator network in this manner, the set of parameters of the approximator network are trained to generate a Q-value prediction for a current time that represents the value of rewards expected over the future.

The client devices 110A, 110B capture participants of a goal-oriented environment and provides the video stream to the online system 130 such that the online system 130 can generate and display Q-value predictions. In one embodiment, the client device 110 includes a browser that allows a user of the client device 110, such as a coordinator managing a learning session, to interact with the online system 130 using standard Internet protocols. In another embodiment, the client device 110 includes a dedicated application specifically designed (e.g., by the organization responsible for the online system 130) to enable interactions among the client device 110 and the servers. In one embodiment, the client device 110 includes a user interface that allows the user of the client device 110 to interact with the online system 130 to view video streams of live or pre-recorded learning sessions and receive information on Q-value predictions on likelihoods that the participants will reach the desired goal.

In one embodiment, a client device 110 is a computing device such as a smartphone with an operating system such as ANDROID® or APPLE® IOS®, a tablet computer, a laptop computer, a desktop computer, or any other type of network-enabled device that includes or can be configured to connect with a camera. In another embodiment, the client device 110 is a headset including a computing device or a smartphone camera for generating an augmented reality (AR) environment to the user, or a headset including a computing device for generating a virtual reality (VR) environment to the user. A typical client device 110 includes the hardware and software needed to connect to the network 122 (e.g., via WiFi and/or 4G or 5G or other wireless telecommunication standards).

For example, when the goal-oriented environment is an in-person learning environment in a classroom, the client device 110 may be a laptop computer connected including or connected to a camera that captures a video stream of the students in the classroom for a learning session. As another example, the client device 110 may be an AR headset worn by the coordinator in the classroom for capturing a video stream of the students. As yet another example, the client device 110 may be a VR headset worn by the coordinator that transforms each participant to a corresponding avatar in the VR environment in the video stream. As another example, when the goal-oriented environment is a virtual learning environment on an online platform, the client devices 110 may be computing devices for each virtual participant that can be used to capture a video stream of a respective participant.

Generally, at least one client device 110 may be operated by the coordinator to view the video stream of participants and predictions generated by the online system 130 in the form of, for example, display information overlaid on the images of the video stream. For example, as shown in FIG. 2, when the client device 110 is communicating with the online system 130 via a browser application, the display information may be overlaid on the video stream. As another example, when the client device 110 is an AR headset, the display information may be in the form of a thought bubble floating next to each participant's head or anywhere else in the scene captured by the AR environment. As another example, when the client device 110 is a VR headset, the user may be allowed navigate around a 360-degree environment, and the display information may be overlaid next to each avatar's head or anywhere else in the VR environment.

Responsive to receiving the prediction information from the online system 130, the coordinator may use the information to improve the learning experience of the participants. For example, an instructor may track the level of comprehension and understanding of a topic at issue from the Q-value predictions and elaborate further on the topic if many students do not appear to be on a path toward reaching the goal of the learning environment. As another example, if the Q-value predictions indicate that a student has comprehended or understood a topic, the instructor may further question the student to confirm whether the student has a correct understanding of the topic.

The network 122 provides a communication infrastructure between the worker devices 110 and the process mining system 130. The network 122 is typically the Internet, but may be any network, including but not limited to a Local Area Network (LAN), a Metropolitan Area Network (MAN), a Wide Area Network (WAN), a mobile wired or wireless network, a private network, or a virtual private network.

The system environment 100 in shown in FIG. 1 and the remainder of the specification describes application of the online system 130 to predict decision states of participants in a learning environment. However, it is appreciated that in other embodiments, the description herein can be applied to any goal-oriented environment that includes one or more participants and a coordinator that may benefit from the generation and display of Q-value predictions. For example, the inference and training process of the approximator network may be applied to a sales call environment that includes a potential client and a salesperson for the sale that may benefit from the Q-value predictions of the client to determine whether the client is on a trajectory toward persuasion to purchase a product of interest. As another example, the inference and training process of the approximator network may be applied to a motivational speech environment that includes an audience and a motivational speaker that may benefit from the Q-value predictions of the audience to determine whether the audience is on a trajectory of changing their behaviors due to the motivational speech.

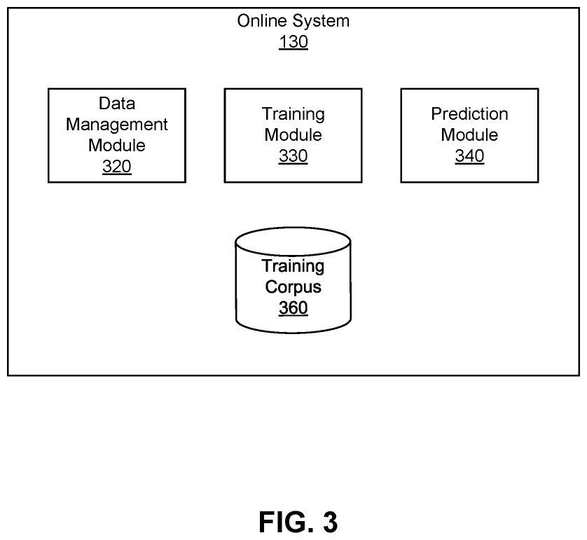

FIG. 3 is an example block diagram of an architecture of the online system 130 in accordance with an embodiment. In the embodiment shown in FIG. 3, the online system 130 includes a data management module 320, a training module 330, and a prediction module 340. The online system 130 also includes a training corpus data store 360. Some embodiments of the online system 130 have different components than those described in conjunction with FIG. 3. Similarly, the functions further described below may be distributed among components of the online system 130 in a different manner than is described here.

The data management module 320 obtains the training dataset stored in the training data store 360. As described above, the training corpus data store 360 includes a reply buffer of multiple instances of transitional scenes that each include a sequence of images of a scene. Specifically, one instance of the replay buffer may include one or more transitional scenes in a sequence from a corresponding video stream, where a transitional scene includes a video image of an environment at a first time and a video image of the environment at a second time that occurred responsive to an action taken in the environment at the first time. The data management module 320 may obtain the training dataset from known instances of goal-oriented environments that have previously occurred and may identify annotations in the images that enclose one or more participants in the scene. The data management module 320 obtains the state information for each image in a training instance, and actions that occurred in the transitional scene.

In one embodiment, when the state information is encoded as decision state and sentiment predictions for one or more participants of an environment, the data management module 320 may generate decision state and sentiment predictions for participants in one or more video frames in the training dataset. In one embodiment, the online system 130 generates decision state and sentiment predictions using a machine learning model prediction model. The prediction model is configured to receive an annotated region enclosing the face of a participant from a video frame and generate an output vector for the participant in the video frame. The output vector indicates whether the individual in the image has achieved one or more desired decision states or sentiments. In one embodiment, each element in the output vector corresponds to a different type of decision state or sentiment, and the value of each element indicates a confidence level that the individual has achieved the corresponding state of mind or sentiment for the element. For example, decision states can include learning states indicating whether an individual achieved a learning state of comprehension or understanding of a certain topic.

In one instance, the data management module 320 obtains the state information for an annotated participant in an image as the concatenation of output vectors for the participant in the image and output vectors for the participant in previous or subsequent images within a predetermined time frame (e.g., five previous video frames) from the image. This type of state information provides temporal context of the decision state and sentiment predictions for the individual. In another instance, the data management module 320 obtains the state information for an annotated participant in an image as the concatenation of the pixel data of the annotation in the image and the pixel data for the annotation in previous or subsequent images within a predetermined time frame from the image. This type of state information also provides temporal context of the facial features of the individual.

In one instance, the data management module 320 obtains state information encoding the cultural context of the goal-oriented environment. For example, the data management module 320 may obtain state information as the geographical region a company is located in, for example, an American company or a Japanese company. As another example, the data management module 320 may obtain state information as an indication of whether the goal-oriented environment is an education setting, a business setting, or the like. This type of state information provides cultural context of the goal-oriented environment that may be helpful for determining whether the desired goal is reached.

In one instance, the data management module 320 obtains the state information for an annotated participant in an image encoding the personal context specific to the participant. For example, the data management module 320 may obtain information on a personality type of the participant, the participant's economic background, geographical background, the like. This type of state information provides personal context of the annotated participant that may be helpful for determining whether the participant will reach the desired goal.

The data management module 320 may also identify actions and rewards for those actions that occurred for a transitional scene in the training dataset. A reward may be assigned for an action that occurred from the first time to the second time of the transitional scene. The reward may be, for example, a positive value if the action was useful, a negative value if the action was harmful, or a zero value if the action was neither useful or harmful to a goal identified for the transitional scene. For example, the data management module 320 may assign a positive reward of +100 to the potential client in a transitional scene for a sales environment in which the potential client appears to be persuaded by the action of a salesperson presenting relevant information in the sales environment. As another example, the data management module 320 may assign a negative reward of −50 to a student in a transitional scene for a learning environment in which the student appears to be more confused by the action of an instructor presenting an unclear slide about the subject matter of interest.

The information for the training dataset, including the actions and rewards, may be obtained by a human operator or a computer model that reviews the images in the training dataset and determines whether the action taken in a transitional scene is helpful to a participant of the transitional scene in achieving the desired goal for the environment. For example, a human operator may review the participant in the transitional scene to determine whether the action was helpful for achieving the desired goal for the environment. As another example, the human operator may review an interval of the video stream that the transitional scene was obtained from to determine whether the action was helpful for achieving the desired goal for the environment based on the context of the video stream.

The training module 330 trains an approximator network coupled to receive a current state for a video frame from a video stream of the environment and generate a Q-value prediction for the video frame. In one embodiment, the training module 330 trains the approximator network by using a temporal difference (“TD”) learning approach. The TD learning approach trains the set of parameters of the approximator network to generate a Q-value prediction for a current time based on a Q-value prediction for the next time.

Specifically, the training module 330 selects a batch of training instances from the training dataset corpus 360 that each include a sequence of annotations for a participant. For a transitional scene in the batch, the training module 330 generates a first estimated Q-value by applying the approximator network with an estimated set of parameters to the state information obtained for the image for the first time. The training module 330 generates a target that is a combination of the reward for the transitional scene and a second estimated Q-value generated by applying the approximator network with the estimated set of parameters to the state information extracted from the image for the second time. The training module 330 determines a loss for the transitional scene as a difference between the first estimated Q-value and the target, and a loss function as a combination of losses for the batch of transitional scenes.

The training module 330 updates the set of parameters for the approximator network to reduce the loss function. This process is repeated with different batches of training instances in the training dataset until a convergence criteria for the set of parameters is reached and the training process is completed. By training the approximator network in this manner, the set of parameters of the approximator network are trained to generate a Q-value prediction for a current time that represents the value of rewards expected over the future.

In one embodiment, the loss function is given by:

$$ℒ ( {Q}_{1} ( s , a ) , {Q}_{2} ( {s}^{′} , a ) ; {θ}_{a} ) = {\sum }_{i ∈ S} {( {Q}_{1} ( s , a ) - ( r ( s , a ) + γ \cdot {Q}_{2} ( {s}^{′} , a ) ) )}^{2}$$

where Q₁(s, a) is the first estimated Q-value for the first image in a transitional scene i generated by applying the approximator network to state information s for the first image, Q₂(s′, a) is the second estimated Q-value for the second image in the transitional scene i generated by applying the approximator network to state information s′ for the second image, r(s,a) is the reward assigned to the transitional scene, and θₐ is the estimated set of parameters for the approximator network. Although the equation above defines the loss function with respect to mean-squared error, it is appreciated that in other embodiments, the loss function can be any other function, such as an L1-norm, an L-infinity norm that indicates a difference between the first estimated Q-value and the target as a combination of the reward and the second estimated Q-value.

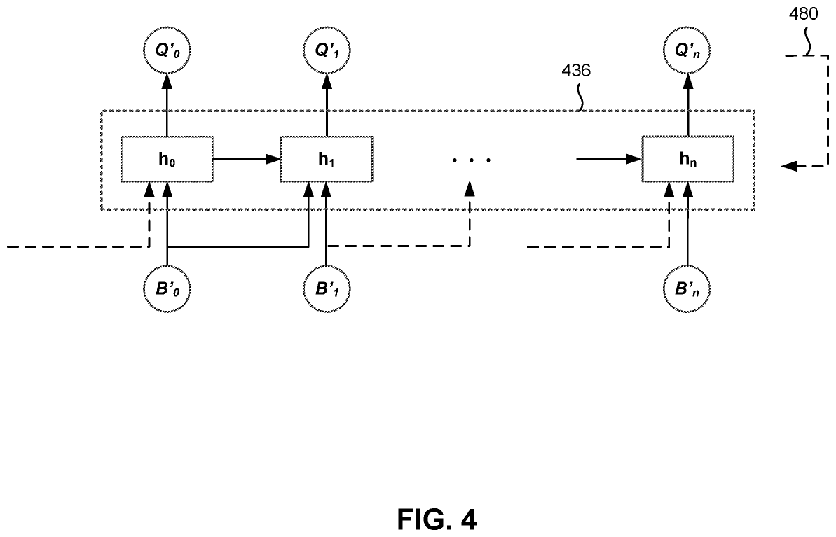

FIG. 4 illustrates a training process of an approximator network 436 with a recurrent neural network (RNN) architecture, in accordance with an embodiment. In one embodiment, the approximator network 436 is structured as an RNN architecture that includes one or more neural network layers with a set of parameters. In one embodiment, the RNN architecture is coupled to receive state information for a sequence of images and sequentially generate Q-value predictions for the images using a same set of trained parameters. Specifically, for an image at a current time, the RNN architecture is coupled to receive the current state for the image and a hidden state for a previous time in the sequence, and generate a hidden state for the current time by applying a first subset of parameters of the approximator network 436. The RNN architecture is further configured to generate the Q-value prediction for the current time by applying a second subset of parameters of the approximator network 436 to the hidden state for the current time. This process can be repeated for subsequent video frames to generate Q-value predictions. While FIG. 4 illustrates an RNN with one hidden state per time step, the RNN architecture of the approximator network 436 may also include other types of RNN's, such as long short-term memory (LSTM) networks, Jordan networks, and the like.

The training module 330 trains the approximator network 436 by sequentially applying the RNN architecture to the state information for the sequence of images for a training instance. Specifically, for an image of a first time in a transitional scene, the training module 330 generates a first estimated hidden state hᵢ by applying a first subset of estimated parameters to the state information for the first time and a previous estimated hidden state hᵢ₋₁ for a previous time. The training module 330 further generates a first estimated Q-value for the first time by applying a second subset of estimated parameters to the hidden state hᵢ. In the example shown in FIG. 4, the state information for an image of a first time t=1 is the concatenation or combination of decision state and sentiment predictions B′₀ and B′₁ for a particular participant.

After, for an image of a second time in the transitional scene, the training module 330 generates a second estimated hidden state hᵢ₊₁ by applying the first subset of estimated parameters to the state information for the second time and the first estimated hidden state hᵢ. The training module 330 further generates a second estimated Q-value for the second time by applying the second subset of estimated parameters to the hidden state hᵢ₊₁. In the example shown in FIG. 4, the state information for an image of a second time t=2 is the concatenation of decision state and sentiment predictions B′₁ and B′₂ for the particular participant. The training module 330 determines the loss for the transitional scene as the difference between the first estimated Q-value and the target as a combination of the reward for the transitional scene and the second estimated Q-value.

The training module 330 repeats this process for remaining transitional scenes in the training instance to determine a total loss 480 for the training instance. The training module 330 repeats the process for other training instances in the training dataset to determine a loss function for the batch, such that the parameters of the approximator network 436 are updated to reduce the loss function.

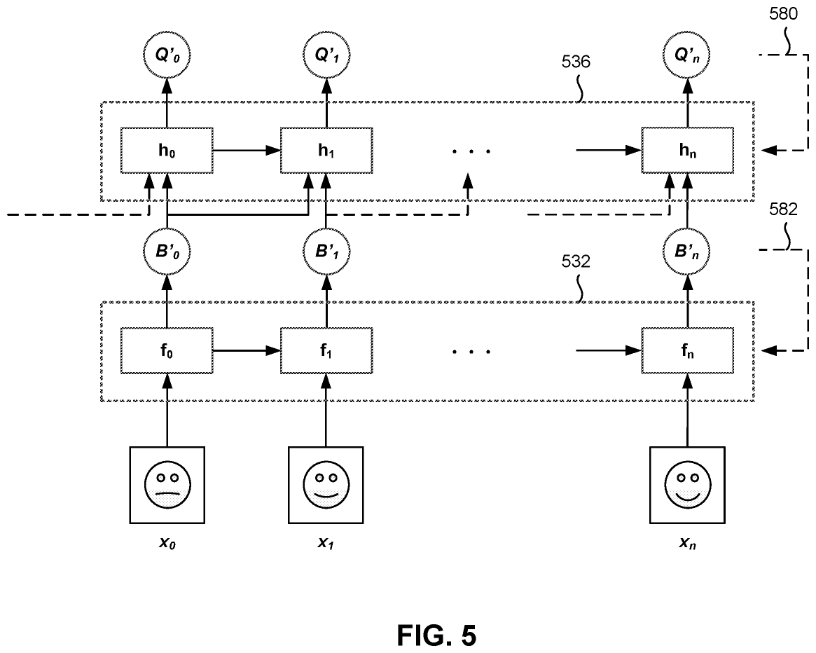

FIG. 5 illustrates a training process of an approximator network 536 coupled to a prediction model 532 with an RNN architecture, in accordance with an embodiment. Different from FIG. 4, the embodiment shown in FIG. 5 includes an approximator network 536 with an RNN architecture that is also coupled to a prediction model 532 with an RNN architecture. In one embodiment, the prediction model 532 is coupled to receive pixel data for a sequence annotations for a participant and sequentially generate decision state and sentiment predictions for the sequence of annotations using a same set of parameters. Specifically, for an image a current time, the prediction model 532 with an RNN architecture is coupled to receive the current pixel data for the participant and a hidden state for a previous time in the sequence, and generate a hidden state for the current time by applying a first subset of parameters of the prediction model. The prediction model 532 with the RNN architecture is further configured to generate the decision state and sentiment prediction for the current time by applying a second subset of parameters for the prediction model to the hidden state for the current time. This process can be repeated for subsequent images to generate decision state and sentiment predictions.

Once the decision state and sentiment predictions are generated by the prediction model 532, the approximator network 536 with the RNN architecture can be similarly trained as described in conjunction with FIG. 4.

Although the approximator network in FIGS. 4 and 5 have been described in conjunction with a structure coupled to receive state information in the form of decision state and sentiment predictions, it is appreciated that this is merely one example and the approximator network can be coupled to receive other types of contextual information (e.g., as described in conjunction with the data management module 320) as appropriate for prediction of Q-values for a goal-oriented environment. For example, the approximator network 536 with the RNN architecture illustrated in FIG. 5 can also be coupled to receive state information encoding the cultural context of the goal-oriented environment at each time in addition to the decision state and sentiment predictions of the participant.

Returning to FIG. 3, the prediction module 340 deploys the approximator network to generate Q-value predictions for incoming or existing video streams of goal-oriented environments. Specifically, in one embodiment, the prediction module 340 may obtain a sequence of annotations for a participant and generate state information for the sequence of annotations. The prediction module 340 may then generate Q-value predictions for the participant by sequentially applying the approximator network to the state information for the sequence of annotations. In one instance, the prediction module 340 generates Q-value predictions for each participant in the video stream, where the Q-value predictions for a participant indicate the likelihood that the participant will reach the desired goal. In another instance, for a given video frame of the environment, the prediction module 340 combines the Q-value predictions for each individual participant to generate an overall Q-value prediction for the environment that indicates

In one embodiment, the online system 130 generates display information including the Q-value predictions as they are generated throughout time, such that the coordinator or another entity managing the environment can monitor whether the participants of the goal-oriented environment are on a path that is progressing toward the desired goal. For example, the online system 130 may generate display information in the form of a plot that includes a horizontal axis representing time (e.g., time of the video frame) and a vertical axis representing Q-value predictions, and display Q-value predictions as they become available over time. For example, if the Q-value predictions are increasing over time, this allows the coordinator to verify that the actions being taken are useful for reaching the desired goal. On the other hand, if the predictions are decreasing over time, this may indicate that the actions being taken are not useful for reaching the desired goal, and the coordinator can modify future action plans to more beneficial ones.

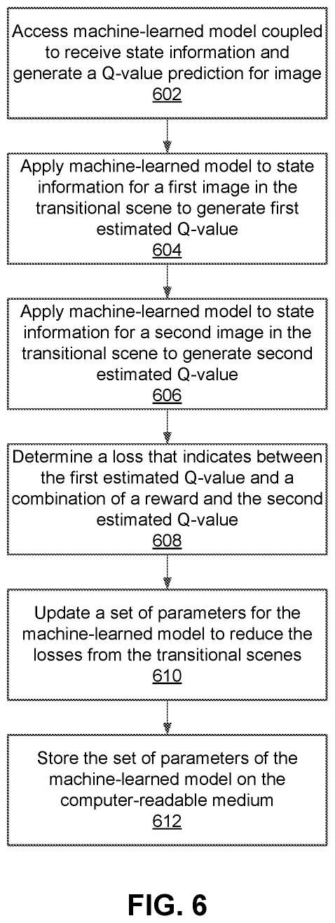

FIG. 6 is a flowchart illustrating a training process of an approximator network, in accordance with an embodiment. In one embodiment, the steps illustrated in FIG. 6 may be performed by the system and modules of the online system 130. However, it is appreciated that in other embodiments, the steps illustrated in FIG. 6 can be performed by any other entity.

The online system 130 accesses 602 a machine learning model coupled to receive state information obtained from an image of a participant in an environment and generate a Q-value prediction for the image. In one embodiment, the machine learning model is an approximator network configured as a neural network model. The Q-value prediction indicates a likelihood that the participant will reach a desired goal of the environment. The online system 130 repeatedly performs, for each transitional scene in a set of training images, applying 604 the machine learning model with a set of estimated parameters to state information for a first image in the transitional scene to generate a first estimated Q-value. The online system 130 applies 606 the machine learning model to state information for a second image in the transitional scene to generate a second estimated Q-value. The second image may be obtained at a time after the first image. The online system 130 determines 608 a loss that indicates a difference between the first estimated Q-value and a combination of a reward for the transitional scene and the second estimated Q-value. Subsequently, the online system 130 updates 610 a set of parameters for the machine learning model by backpropagating one or more error terms from the losses of the transitional scenes in the set of training images. The online system 130 stores 612 the set of parameters of the machine learning model on the computer-readable storage medium.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for training a machine learning model, the method comprising:
accessing the machine learning model, the machine learning model configured to receive state information obtained from an image of a participant in an environment and generate a Q-value prediction for the image, the Q-value prediction indicating a likelihood that the participant will reach a desired goal of the environment;
repeatedly performing, for each transitional scene in a set of training images, the steps:
applying the machine learning model to state information for a first image in the transitional scene to generate a first estimated Q-value,
applying the machine learning model to state information for a second image in the transitional scene to generate a second estimated Q-value, the second image obtained at a time after the first image,
determining a loss that indicates a difference between the first estimated Q-value and a combination of a reward for the transitional scene and the second estimated Q-value, and
updating a set of parameters of the machine learning model by backpropagating one or more error terms obtained from the losses of the transitional scenes in the set of training images; and
storing the set of parameters of the machine learning model on a computer-readable storage medium.

2. The method of claim 1, wherein the machine learning model generates a Q-value prediction for the image by applying an approximator network to the state information for the image.

3. The method of claim 2, wherein the approximator network comprises a neural network model trained by a reinforcement learning process.

4. The method of claim 2, wherein the machine learning model generates a Q-value prediction for the image by applying the approximator network to the state information for the image.

5. The method of claim 2, wherein the approximator network is trained to generate a Q-value prediction for the image of a current time based on a Q-value prediction for an image of a next time.

6. The method of claim 5, wherein the training data for the approximator network includes a plurality of transitional scenes, where a transitional scene comprises an image of an environment at a first time and an image of the environment at a second time that occurred responsive to an action taken in the environment at the first time.

7. The method of claim 6, wherein the training data for the approximator network further includes a reward for a transition that indicates whether the action taken is useful for reaching the desired goal.

8. The method of claim 7, wherein the reward is a positive value if the action was useful, a negative value if the action was harmful, or a zero value if the action was neither useful or harmful.

9. The method of claim 1, wherein the state information comprises temporal context, cultural context, or personal context.

10. The method of claim 1, wherein the state information comprises decision state predictions for the participant of the environment over a window of time for temporal context.

11. The method of claim 1, wherein the state information comprises pixel data for the participant obtained from a video stream of the environment over a window of time for temporal context.

12. The method of claim 1, wherein the state information comprises a prediction on whether the participant has achieved a state of understanding or comprehension.

13. A Q-value approximator product stored on a non-transitory computer readable storage medium, wherein the Q-value approximator product is manufactured by a process comprising:
obtaining training data that comprises a plurality of training images;
accessing a machine learning model, the machine learning model configured to receive state information obtained from an image of a participant in an environment and generate a Q-value prediction for the image, the Q-value prediction indicating a likelihood that the participant will reach a desired goal of the environment:
for each of a plurality of transitional scenes in the training images of the training data:
applying the machine learning model to state information for a first image in the transitional scene to generate a first estimated Q-value,
applying the machine learning model to state information for a second image in the transitional scene to generate a second estimated Q-value, the second image obtained at a time after the first image,
determining a loss that indicates a difference between the first estimated Q-value and a combination of a reward for the transitional scene and the second estimated Q-value, and
updating a set of parameters of the machine learning model by backpropagating one or more error terms obtained from the losses of the transitional scenes in the set of training images; and
storing the set of parameters of the machine learning model on the non-transitory computer-readable storage medium as parameters of the Q-value approximator product.

14. The Q-value approximator product of claim 13, wherein the machine learning model generates a Q-value prediction for the image by applying an approximator network to the state information for the image.

15. The Q-value approximator product of claim 14, wherein the approximator network comprises a neural network model trained by a reinforcement learning process.

16. The Q-value approximator product of claim 14, wherein the machine learning model generates a Q-value prediction for the image by applying the approximator network to the state information for the image.

17. The Q-value approximator product of claim 14, wherein the approximator network is trained to generate a Q-value prediction for the image of a current time based on a Q-value prediction for an image of a next time.

18. The Q-value approximator product of claim 17, wherein the training data for the approximator network includes a plurality of transitional scenes, where a transitional scene comprises an image of an environment at a first time and an image of the environment at a second time that occurred responsive to an action taken in the environment at the first time.

19. The Q-value approximator product of claim 18, wherein the training data for the approximator network further includes a reward for a transition that indicates whether the action taken is useful for reaching the desired goal.

20. The Q-value approximator product of claim 19, wherein the reward is a positive value if the action was useful, a negative value if the action was harmful, or a zero value if the action was neither useful or harmful.

21. The Q-value approximator product of claim 13, wherein the state information comprises temporal context, cultural context, or personal context.

22. The Q-value approximator product of claim 13, wherein the state information comprises decision state predictions for the participant of the environment over a window of time for temporal context.

23. The Q-value approximator product of claim 13, wherein the state information comprises pixel data for the participant obtained from a video stream of the environment over a window of time for temporal context.

24. The Q-value approximator product of claim 13, wherein the state information comprises a prediction on whether the participant has achieved a state of understanding or comprehension.

25. A method of using the Q-value approximator product of claim 13, the method comprising:
receiving a video stream comprising a plurality of video frames, the video stream including at least one target participant in a target environment;
applying the received video frames to the Q-value approximator product, the Q-value approximator product generating a series of Q-value predictions, each Q-value prediction indicating a likelihood that the target participant will reach a desired goal of the target environment at a different time in the video stream; and
displaying, via a user interface coupled to the Q-value approximator product, the series of Q-value predictions as the series of Q-value predictions are generated throughout time.
